(19) United States
(12) Patent Application Publication
(10) Pub. No.: US 2026/0349952 A1
(43) Pub. Date: Nov. 5, 2026

(54) DIE-TO-DIE COMMUNICATION WITH CHANNEL MAPPING

(71) Applicant: Samsung Electronics Co., Ltd., Suwon-si (KR)

(72) Inventors: Solbi Han, Suwon-si (KR); Geunho Choi, Suwon-si (KR); Joonyoung Chang, Suwon-si (KR); Youngduke Seo, Suwon-si (KR); Sungcheol Park, Suwon-si (KR)

(21) Appl. No.: 19/547,357

(22) Filed: Feb. 23, 2026

(30) Foreign Application Priority Data
Apr. 30, 2025 (KR) 10-2025-0057040

(51) Int. Cl. G06F 13/42; G06F 13/40

(52) U.S. Cl. CPC G06F 13/4282; G06F 13/404; G06F 2213/0052

(57) ABSTRACT

A die includes a bus including a plurality of bus channels, at least one function block connected to the bus, an interface circuit configured to provide communication with another die through a plurality of die-to-die (D2D) channels, and a routing circuit configured to perform channel mapping between the bus and the interface circuit based on a signal received through the bus.

### BACKGROUND

A wafer manufactured through a semiconductor manufacturing process may be diced into a plurality of dies, and a die may be designed to have a unique function. Heterogeneous dies may be included in one package for providing various functions, or homogeneous dies may be included in one package for high-speed parallel processing. In addition, a plurality of dies may be included in one package to prevent process yield degradation and enhance cost efficiency. Dies included in a package may communicate with each other, and communication between dies is routed through interconnects exposed outside the dies, and therefore may involve different requirements compared to intra-die communication between internal blocks.

### SUMMARY

Some aspects of the present disclosure provide die-to-die (D2D) communication, and for example, low power D2D devices providing dynamic channel distribution, and methods of operation thereof.

For example, some aspects of the present disclosure provide dies, devices, and methods providing D2D communication with high efficiency.

According to some implementations of the present disclosure, there is provided a die, including a bus including a plurality of bus channels, at least one function block connected to the bus, an interface circuit configured to provide communication with another die through a plurality of die-to-die (D2D) channels, and a routing circuit configured to perform channel mapping between the bus and the interface circuit based on a signal received from the bus.

According to some implementations of the present disclosure, there is provided a method of communicating between a die another die through a plurality of die-to-die (D2D) channels, the method including, mapping each bus channel of a plurality of bus channels included in a bus to at least one of the plurality of D2D channels. The bus is connected to at least one function block of the die. The mapping may include mapping a first bus channel of the plurality of bus channels to two or more D2D channels of the plurality of D2D channels.

According to some implementations of the present disclosure, there is provided a device, including a first die and a second die communicatively connected through a plurality of die-to-die (D2D) channels. The first die may include a first bus including a plurality of first bus channels and a first routing circuit configured to perform first channel mapping between the plurality of first bus channels and the plurality of D2D channels. The second die may include a second bus including a plurality of second bus channels and a second routing circuit configured to perform second channel mapping between the plurality of second bus channels and the plurality of D2D channels. A mapping between each first bus channel of the plurality of first bus channels and one or more D2D channels of the plurality of D2D channels, is identical to a mapping between a corresponding second bus channel of the plurality of second bus channels and the one or more D2D channels of the plurality of D2D channels.

### BRIEF DESCRIPTION OF THE FIGURES

The foregoing and other aspects, features, and advantages provided by the present disclosure will become apparent and more readily appreciated from the following description taken in conjunction with the accompanying drawings, of which:

FIG. 1 is a block diagram illustrating an example of a device;

FIG. 2 is a block diagram illustrating an example of a die;

FIG. 3 is a block diagram illustrating an example of a device;

FIG. 4 is a block diagram illustrating an example of an interface circuit;

FIGS. 5A and 5B are block diagrams illustrating examples of a routing circuit;

FIG. 6 is a diagram illustrating an example of D2D communication;

FIGS. 7A and 7B are block diagrams illustrating examples of a device;

FIG. 8 is a block diagram illustrating an example of a device;

FIG. 9 is a flowchart illustrating an example of a method for D2D communication;

FIG. 10 is a flowchart illustrating an example of a method for D2D communication;

FIGS. 11A and 11B are flowcharts illustrating examples of a method for D2D communication; and

FIG. 12 is a block diagram illustrating an example of a system-on-chip (SoC).

### DETAILED DESCRIPTION

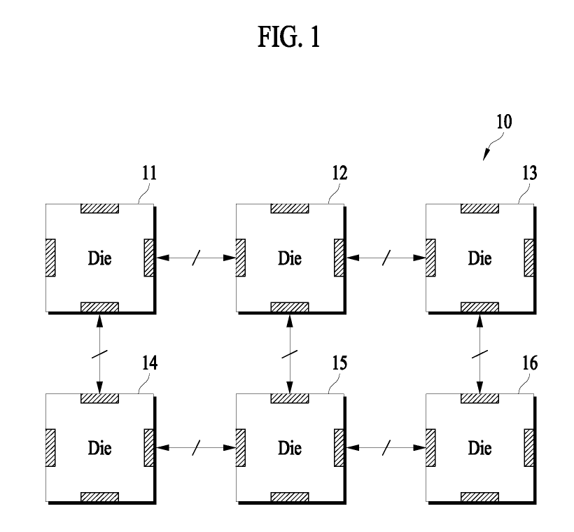

FIG. 1 is a block diagram illustrating an example of a device 10. As illustrated in FIG. 1, the device 10 may include a first die 11, a second die 12, a third die 13, a fourth die 14, a fifth die 15, and a sixth die 16. It should be noted that the number of dies included in the device 10 is not limited to what is illustrated in FIG. 1. In some implementations, the device 10 may be a semiconductor package including the first die 11, the second die 12, the third die 13, the fourth die 14, the fifth die 15, and the sixth die 16.

A wafer manufactured through a semiconductor manufacturing process may be diced into a plurality of dies. A die may be designed to have a unique function, and, in some implementations, dies that are diced from one wafer may provide the same function. The device 10 may include homogeneous dies or heterogeneous dies. In some implementations, the first die 11, the second die 12, the third die 13, the fourth die 14, the fifth die 15, and the sixth die 16 may be homogeneous, and each may provide the same function. In some implementations, two or more dies among the first die 11, the second die 12, the third die 13, the fourth die 14, the fifth die 15, and the sixth die 16 may be heterogeneous, and each may provide different functions. For example, the first die 11, the second die 12, the third die 13, the fourth die 14, the fifth die 15, and the sixth die 16 may include a memory die, an input/output (IO) die, a core die, and/or a sensor die.

In the device 10, each of the first die 11, the second die 12, the third die 13, the fourth die 14, the fifth die 15, and the sixth die 16 may communicate with another die. In some implementations, each of the first die 11, the second die 12, the third die 13, the fourth die 14, the fifth die 15, and the sixth die 16 may communicate with another die directly, and the communication method may be referred to as die-to-die (D2D) communication. For example, as illustrated in FIG. 1, the first die 11 may directly communicate with the second die 12 and the fourth die 14, and the second die 12 may directly communicate with the first die 11, the third die 13, and the fifth die 15, and the third die 13 may directly communicate with the second die 12 and the sixth die 16. D2D communication may be based on an arbitrary protocol, and, in some implementations, two or more different protocols may be used for D2D communication in the device 10.

An application such as high performance computing (HPC) and artificial intelligence (AI), which rely on parallel processing of a complex computational task, may utilize high D2D communication bandwidth, and accordingly, multi-channel D2D communication may be adopted. The multi-channel D2D communication may include a plurality of channels, and high bandwidth may be achieved through the plurality of channels. Herein, unless otherwise described, D2D communication may be assumed to be the multi-channel D2D communication, and a channel included in D2D communication may be referred to as a D2D channel.

The D2D channel may include an interconnect exposed outside a die. In some implementations, the first die 11, the second die 12, the third die 13, the fourth die 14, the fifth die 15, and the sixth die 16 may be mounted on an interposer, and the D2D channel may include a pattern of an interposer. In some implementations, at least two dies among the first die 11, the second die 12, the third die 13, the fourth die 14, the fifth die 15, and the sixth die 16 may be stacked, and the D2D channel may include a wire for wire bonding, a bump for chip-to-chip bonding, or a through silicon via (TSV). Accordingly, when compared to communication between blocks within the die, such as bus communication, the D2D channel may exhibit high resistance and/or capacitance, which may lead to relatively high power consumption.

Hereinafter, as described later with reference to the diagrams, the number of D2D channels may be dynamically adjusted. Accordingly, power consumption of D2D communication may be reduced, and power consumption of the device 10 may also be reduced. In addition, interleaved transactions may be transmitted and received through D2D channels, which may improve the efficiency of D2D communication. As the efficiency of D2D communication increases, an idle period may occur or be extended during D2D communication, which may consequently reduce power consumption.

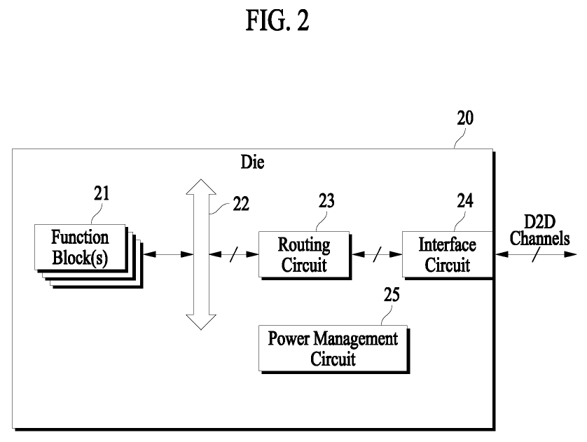

FIG. 2 is a block diagram illustrating an example of a die 20. As described above with reference to FIG. 1, the die 20 may be included in one device together with another die and may communicate with another die through D2D channels. As illustrated in FIG. 2, the die 20 may include at least one function block 21, a bus 22, a routing circuit 23, an interface circuit 24, and a power management circuit 25.

The at least one function block 21 may be connected to the bus 22 and may provide a designed function. For example, the at least one function block 21 may include at least one of a programmable function block such as a central processing unit (CPU), a graphics processing unit (GPU), or a neural processing unit (NPU), a reconfigurable function block such as a field programmable gate array (FPGA), and an intellectual property (IP) function block that provides a fixed function, such as a hardware accelerator. The routing circuit 23 described later may also provide D2D communication with another die as a function block connected to the bus 22.

The bus 22 may provide communication between function blocks included in the die 20, e.g., between the at least one function block 21 and the routing circuit 23. The bus 22 may be based on an on-chip communication bus protocol, and the at least one function block 21 and the routing circuit 23 may communicate with each other through the bus 22 based on the on-chip communication bus protocol. The on-chip communication bus protocol may include advanced microcontroller bus architecture (AMBA), Wishbone, CoreConnect, IPBus, Avalon, hyper transport (HT), quick path interconnect (QPI), and TileLink, but is not limited thereto.

The bus 22 may include a plurality of channels and may be referred to as a multi-channel bus. For example, the bus 22 may be an advance extensible interface (AXI) bus, which is a part of AMBA specification, and the AXI bus may include a read address channel, a write address channel, a read data channel, a write data channel, and a write response channel. In some implementations, channels included in the bus 22 may operate independently each other. Herein, a channel included in the bus 22 may be referred to as a bus channel, and the bus 22 may be referred to as a system bus.

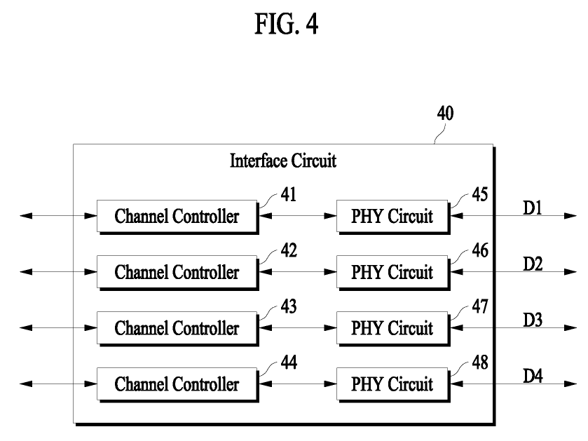

The interface circuit 24 may provide D2D communication between the die 20 and another die. As described above with reference to FIG. 1, D2D communication may include a plurality of D2D channels, and the interface circuit 24 may provide D2D communication through the plurality of D2D channels. To this end, the interface circuit 24 may include a plurality of components, each of which corresponds to the plurality of D2D channels. An example of the interface circuit 24 may be described later with reference to FIG. 4.

The routing circuit 23 may perform channel mapping between the bus 22 and the interface circuit 24. As described above, the bus 22 may include a plurality of bus channels as a multi-channel bus, and D2D communication may also include a plurality of D2D channels. The routing circuit 23 may perform channel mapping between the plurality of bus channels and the plurality of D2D channels based on a signal received from the bus 22. For example, when the at least one function block 21 transmits data to another die, the routing circuit 23 may generate transactions (hereinafter D2D transactions) from a transaction (hereinafter referred to as a bus transaction) received from the bus 22 and provide the D2D transactions to the interface circuit 24 to be interleaved. In addition, when the at least one function block 21 receives data from another die, the routing circuit 23 may receive D2D transactions from the interface circuit 24, assemble the D2D transactions, and provide an assembled transaction, in other words, a bus transaction, to the at least one function block 21 through the bus 22. Accordingly, the number of D2D channels may be dynamically adjusted, and power consumption of D2D communication may be reduced. In addition, interleaved transactions may be transmitted and received through scheduled D2D channels, which may improve the transmission speed and the efficiency.

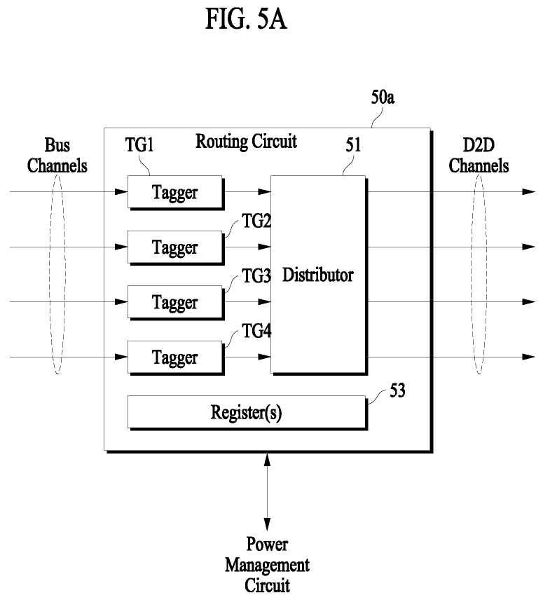

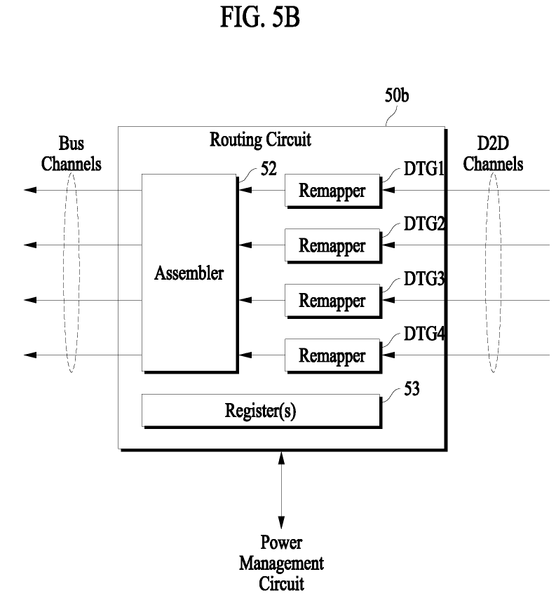

The power management circuit 25 may control power that is provided to elements of the die 20. For example, the power management circuit 25 may generate one or more internal supply voltages from an external supply voltage that the die 20 receives and provide the one or more internal supply voltages to the elements of the die 20, for example, the at least one function block 21, the routing circuit 23, and the interface circuit 24. In some implementations, at least one of bus channels and/or D2D channels may not be used based on the channel mapping of the routing circuit 23, and a sub-circuit corresponding to a channel that is not used may be powered down by the power management circuit 25. For example, the power management circuit 25 may block a supply voltage to power down the sub-circuit. To identify the sub-circuit that is powered down, the power management circuit 25 may communicate with the routing circuit 23 as described later with reference to FIGS. 5A and 5B.

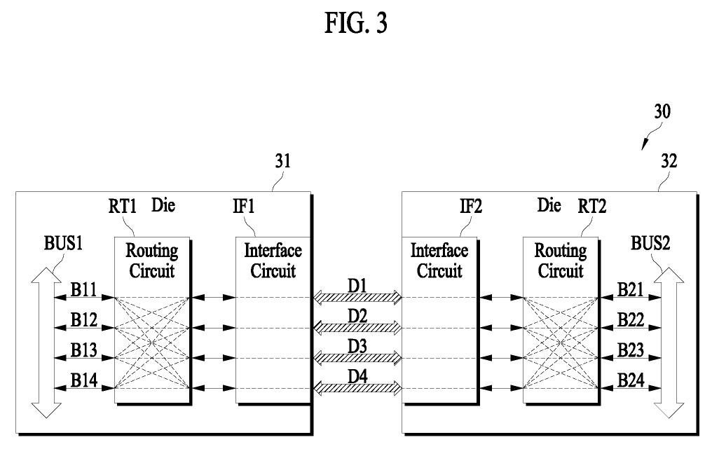

FIG. 3 is a block diagram illustrating an example of a device 30. For example, the block diagram of FIG. 3 illustrates the device 30 including a first die 31 and a second die 32 that communicate with each other through four D2D channels. Hereinafter, D2D communication including the four D2D channels will be mainly described with reference to the diagrams, but it should be noted that the number of D2D channels included in D2D communication is not limited thereto. In description of FIG. 3, it is assumed that the first die 31 transmits data to the second die 32, and redundant details already provided in the aforementioned description with reference to the diagrams will be omitted.

With reference to FIG. 3, the first die 31 and the second die 32 may communicate with each other through first to fourth D2D channels D1 to D4. For example, FIG. 3 illustrates that all of the first to fourth D2D channels D1 to D4 are used for communication between the first die 31 and the second die 32. The first die 31 may include a first bus BUS1, a first routing circuit RT1, and a first interface circuit IF1, and the second die 32 may include a second bus BUS2, a second routing circuit RT2, and a second interface circuit IF2. The first die 31 may further include at least one function block connected to the first bus BUS1, and the second die 32 may also further include at least one function block connected to the second bus BUS2.

Each of the first bus BUS1 and the second bus BUS2 may be a multi-channel bus. For example, as illustrated in FIG. 3, the first bus BUS1 may include first to fourth bus channels B11 to B14, and the second bus BUS2 may also include first to fourth bus channels B21 to B24. In some implementations, the number of bus channels included in the first bus BUS1 may be identical to the number of bus channels included in the second bus BUS2. In some implementations, the number of bus channels included in the first bus BUS1 may be equal to or less than the number of D2D channels.

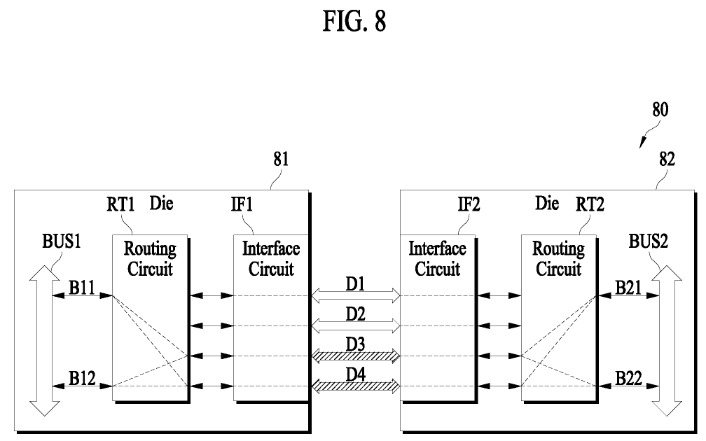

The first interface circuit IF1 and the second interface circuit IF2 may transmit and receive D2D transactions through the first to fourth D2D channels D1 to D4. As described later with reference to FIG. 4, each of the first interface circuit IF1 and the second interface circuit IF2 may include four components corresponding to the first to fourth D2D channels D1 to D4. As illustrated in FIG. 3, when a signal is transmitted through the first to fourth D2D channels D1 to D4, all of the four components included in each of the first interface circuit IF1 and the second interface circuit IF2 may operate. As described later with reference to FIG. 8, when a signal is transmitted through some of the first to fourth D2D channels D1 to D4, some of the four components included in each of the first interface circuit IF1 and the second interface circuit IF2 may be powered down.

The first routing circuit RT1 may perform channel mapping between the first to fourth bus channels B11 to B14 and the first to fourth D2D channels D1 to D4. For example, the first routing circuit RT1 may identify channel mapping based on a signal received through the first bus BUS1. The first routing circuit RT1 may map each of the first to fourth bus channels B11 to B14 to one of the first to fourth D2D channels D1 to D4 based on the identified channel mapping. Accordingly, a transaction received through each of the first to fourth bus channels B11 to B14 may be transmitted to the second die 32 through at least one of the mapped first to fourth D2D channels D1 to D4. Similarly, the second routing circuit RT2 may also perform channel mapping between the first to fourth bus channels B21 to B24 and the first to fourth D2D channels D1 to D4. The channel mapping of the first routing circuit RT1 and the channel mapping of the second routing circuit RT2 may be identical. For example, D2D channels mapped to the first bus channel B11 in the first die 31 may be mapped to the first bus channel B21 in the second die 32. Accordingly, a function block of the first die 31 may detect that a function block of the second die 32 is connected to the first bus BUS1, and the function block of the second die 32 may detect that the function block of the first die 31 is connected to the second bus BUS2.

In some implementations, the first routing circuit RT1 may map one of the first to fourth bus channels B11 to B14 to two or more D2D channels among the first to fourth D2D channels D1 to D4. For example, as illustrated in FIG. 3, the first routing circuit RT1 may map the first bus channel B11 to the first to fourth D2D channels D1 to D4. To this end, the first routing circuit RT1 may generate a plurality of D2D transactions from a bus transaction received through the first bus channel B11 and provide the plurality of D2D transactions to the first interface circuit IF1 for interleaved transmission to the second die 32 through the first to fourth D2D channels D1 to D4. In addition, the second routing circuit RT2 may receive the plurality of D2D transactions received through the first to fourth D2D channels D1 to D4 from the second interface circuit IF2 and generate a bus transaction from the plurality of D2D transactions to transmit the bus transaction through the first bus channel B21. Accordingly, the bus transaction received from the first bus channel B11 may be transmitted through the first to fourth D2D channels D1 to D4, and transmission time may be shortened.

FIG. 4 is a block diagram illustrating an example of an interface circuit 40. For example, FIG. 4 illustrates the interface circuit 40 providing D2D communication including first to fourth D2D channels D1 to D4. As described above with reference to FIG. 3, the interface circuit 40 may be disposed between D2D channels and a routing circuit. As illustrated in FIG. 4, the interface circuit 40 may include first to fourth channel controllers 41 to 44 and first to fourth physical layer (PHY) circuits 45 to 48. Herein, each of the first to fourth channel controllers 41 to 44 and each of the first to fourth PHY circuits 45 to 48 may be referred to as a sub-circuit of the interface circuit 40.

The first to fourth PHY circuits 45 to 48 may implement a PHY of D2D communication. For example, the PHY may correspond to the lowest layer in an open systems interconnection (OSI) reference model and provide a physical way for transmitting and receiving a signal. In some implementations, each of the first to fourth PHY circuits 45 to 48 may perform signal encoding, signal decoding, and channel equalization, and handle a preamble for synchronization. As illustrated in FIG. 4, the first to fourth PHY circuits 45 to 48 may correspond to the first to fourth D2D channels D1 to D4.

The first to fourth channel controllers 41 to 44 may implement an upper layer of D2D communication. For example, the first to fourth channel controllers 41 to 44 may implement upper layers of the PHY, for example, a data link layer. The first to fourth channel controllers 41 to 44 may detect and correct an error that may occur in the PHY and implement a protocol defined to establish and terminate an access. The first to fourth channel controllers 41 to 44 may handle transactions provided from the routing circuit and provide handled transactions to each of the first to fourth PHY circuits 45 to 48. In addition, the first to fourth channel controllers 41 to 44 may handle transactions provided from the first to fourth PHY circuits 45 to 48 and provide handled transactions to the routing circuit. As illustrated in FIG. 4, the first to fourth channel controllers 41 to 44 may correspond to the first to fourth D2D channels D1 to D4.

In some implementations, the first to fourth D2D channels D1 to D4 may be independent from each other. For example, the first to fourth channel controllers 41 to 44 may implement an upper layer independently from each other, and the first to fourth PHY circuits 45 to 48 may also implement a PHY independently from each other. Accordingly, a channel controller and a PHY circuit corresponding to D2D channels not used among the first to fourth D2D channels D1 to D4 may be powered down, and power consumption of the interface circuit 40 may be reduced. As described below with reference to the diagrams, D2D channels may be scheduled by the routing circuit, and as the channel controller and the PHY circuit corresponding to a D2D channel that is not used are powered down, power consumption of the interface circuit 40, a die including the interface circuit 40, and a device including the die may be reduced.

FIGS. 5A and 5B are block diagrams illustrating examples of a routing circuit. For example, a block diagram of FIG. 5A illustrates a routing circuit 50a including elements transmitting a transaction, and a block diagram of FIG. 5B illustrates a routing circuit 50b including elements receiving a transaction. In some implementations, the elements illustrated in FIGS. 5A and 5B may be included in one routing circuit. As described above with reference to the diagrams, the routing circuits 50a and 50b may be disposed between a system bus and an interface circuit and may perform channel mapping between bus channels and D2D channels. Hereinafter, redundant details in the descriptions of FIGS. 5A and 5B will be omitted.

Referring to FIG. 5A, the routing circuit 50a may include a first tagger TG1, a second tagger TG2, a third tagger TG3, and a fourth tagger TG4, a distributor 51, and at least one register 53. The at least one register 53 may store channel mapping information. For example, a function block included in a die together with the routing circuit 50a may provide channel mapping information to the routing circuit 50a through a bus. The routing circuit 50a may store the channel mapping information in the at least one register 53 based on a signal received through the bus. In some implementations, the at least one register 53 may be configured when a device including the routing circuit 50a boots. In some implementations, the at least one register 53 may be configured by a function block during an operation of the device. Accordingly, channel mapping may be dynamically configured and optimally configured depending on a communication state of dies. In some implementations, reconfiguration of the channel mapping through configuring the at least one register 53 may be performed during an idle period of a channel.

Each of the first tagger TG1, the second tagger TG2, the third tagger TG3, and the fourth tagger TG4 may receive bus transactions from a first bus channel, a second bus channel, a third bus channel, and a fourth bus channel. The first tagger TG1, the second tagger TG2, the third tagger TG3, and the fourth tagger TG4 may tag the bus transactions with identification information of a bus channel. For example, the first tagger TG1 may tag first identification information of the first bus channel, and the second tagger TG2 may tag second identification information of the second bus channel, and the third tagger TG3 may tag third identification information of the third bus channel, and the fourth tagger TG4 may tag fourth identification information of the fourth bus channel. As described later, tagged identification information of a bus channel may be used at a receiving side to identify the bus channel. Each of the first tagger TG1, the second tagger TG2, the third tagger TG3, and the fourth tagger TG4 may provide a tagged bus transaction to the distributor 51. In some implementations, each of the first tagger TG1, the second tagger TG2, the third tagger TG3, and the fourth tagger TG4 may obtain identification information of a channel based on a value of the at least one register 53, and accordingly, identification information of the channel may change through configuration of the at least one register 53. In some implementations, the first tagger TG1, the second tagger TG2, the third tagger TG3, and the fourth tagger TG4 may track a transaction. For example, the first tagger TG1, the second tagger TG2, the third tagger TG3, and the fourth tagger TG4 may transmit a transaction and receive a response received through a D2D channel from the distributor 51. The first tagger TG1, the second tagger TG2, the third tagger TG3, and the fourth tagger TG4 may identify whether transmission of the transaction ends based on the response.

The distributor 51 may receive a bus transaction from the first tagger TG1, the second tagger TG2, the third tagger TG3, and the fourth tagger TG4 and generate a D2D transaction by interleaving the bus transaction based on channel mapping information. For example, the distributor 51 may access the at least one register 53 and identify channel mapping information stored in the at least one register 53. The distributor 51 may identify at least one D2D channel corresponding to a bus channel based on the channel mapping information and provide transactions, which are interleaved from a bus transaction received through the bus channel, to the interface circuit to be transmitted through at least one identified D2D channel. In some implementations, the distributor 51 may tag interleaved transactions with identification information of the bus channel.

In some implementations, the distributor 51 may interleave the bus transaction based on a size. For example, the distributor 51 may generate transactions with a predetermined size from the bus transaction and perform interleaving to transmit the transactions alternately through identified D2D channels. In some implementations, the distributor 51 may identify a size of a transaction based on a value stored in the at least one register 53, and accordingly, the unit of interleaving, in other words, the transaction size may be adjusted through configuration of the at least one register 53. In some implementations, the distributor 51 may generate transactions with a predetermined size based on an address used for the bus transaction. For example, when interleaving is performed in 1KB units, the distributor 51 may generate transactions at address intervals of 0x400. For example, the distributor 51 may generate transactions to be interleaved based on an eleventh bit from a least significant bit (LSB) of the address and at least one or more additional higher-order bits. For example, when the transactions are interleaved across four channels in 1KB units, the transactions may be assigned to one of four channels based on a 2-bit value from the address, in other words, a value of a twelfth bit and the eleventh bit.

In some implementations, the routing circuit 50a may communicate with a power management circuit, for example, power management circuit 25 of FIG. 2. As described later with reference to FIG. 8, at least one of the D2D channels may not be used depending on channel mapping. A sub-circuit corresponding to at least one D2D channel not used in the routing circuit 50a and/or the interface circuit may be powered down. To this end, the routing circuit 50a may provide information of a powered down sub-circuit to the power management circuit, and the power management circuit may power down the sub-circuit by blocking supply voltage for the sub-circuit.

Referring to FIG. 5B, the routing circuit 50b may include an assembler 52, the at least one register 53, and first to fourth remappers DTG1 to DTG4. The first to fourth remappers DTG1 to DTG4 may receive D2D transactions received from first to fourth D2D channels from an interface circuit. As described above, the D2D transactions may include identification information of a bus channel tagged in a die on a transmitting side. The first to fourth remappers DTG1 to DTG4 may extract the identification information of the bus channel included in the D2D transactions and provide extracted identification information to the assembler 52. The D2D transactions may be transactions interleaved from a bus transaction in the die on the transmitting side.

The assembler 52 may receive identification information of a D2D transaction and the bus channel from the first to fourth remappers DTG1 to DTG4. The assembler 52 may assemble the D2D transactions corresponding to identification information of an identical bus channel and generate an assembled transaction, in other words, a bus transaction. The assembler 52 may transmit the bus transaction through the bus channel corresponding to the identification information.

In some implementations, the at least one register 53 may store mapping information of the bus channel. For example, the first to fourth remappers DTG1 to DTG4 may identify the mapping information of the bus channel by accessing the at least one register 53 and identify a bus channel on a receiving side corresponding to identification information of a bus channel on a transmitting side obtained from the D2D transactions received through the first to fourth D2D channels based on the mapping information of the bus channel. The first to fourth remappers DTG1 to DTG4 may provide information of an identified bus channel on the receiving side to the assembler 52 together with a transaction. As another example, the assembler 52 may identify the mapping information of the bus channel by accessing the at least one register 53. For example, the at least one register 53 may store mapping information between the bus channel on the transmitting side and the bus channel on the receiving side. The assembler 52 may identify the bus channel on the receiving side corresponding to the identification information of the bus channel on the transmitting side provided from the first to fourth remappers DTG1 to DTG4 based on the mapping information of the bus channel stored in the at least one register 53, may assemble the D2D transactions corresponding to an identified bus channel on the receiving side, and may transmit an assembled transaction, in other words, a bus transaction through the bus channel on the receiving side.

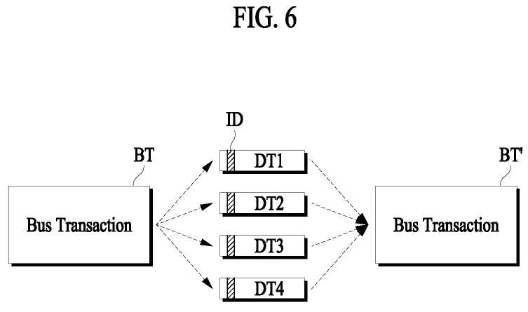

FIG. 6 is a diagram illustrating an example of D2D communication. For example, FIG. 6 illustrates examples of a bus transaction and a D2D transaction in the D2D communication. In some implementations, the D2D communication of FIG. 6 may be performed in the device 30 of FIG. 3. Hereinafter, FIG. 6 will be described with reference to FIG. 3.

Referring to FIG. 6, a bus transaction BT may occur. For example, the bus transaction BT may be generated by a function block connected to the first bus BUS1, and the first routing circuit RT1 of the first die 31 may receive the bus transaction BT through the first bus channel B11. The first routing circuit RT1 may identify that the first bus channel B11 is mapped to the first to fourth D2D channels D1 to D4 based on channel mapping information. Accordingly, the first routing circuit RT1 may generate first to fourth D2D transactions DT1 to DT4 from the bus transaction BT. In some implementations, the first to fourth D2D transactions DT1 to DT4 may have an identical size, and the first routing circuit RT1 may additionally generate a D2D transaction depending on a size of the bus transaction BT. As illustrated in FIG. 6, each of the first to fourth D2D transactions DT1 to DT4 may include identification information ID representing the first bus channel B11. The first routing circuit RT1 may provide the first to fourth D2D transactions DT1 to DT4 to the first interface circuit IF1 to be independently transmitted through the first to fourth D2D channels D1 to D4.

The second routing circuit RT2 of the second die 32 may receive the first to fourth D2D transactions DT1 to DT4, which are received through the first to fourth D2D channels D1 to D4, from the second interface circuit IF2. The second routing circuit RT2 may extract the identification information ID from the first to fourth D2D transactions DT1 to DT4, and based on the identification information ID, identify the first bus channel B21. The second routing circuit RT2 may assemble the first to fourth D2D transactions DT1 to DT4 corresponding to the first bus channel B21 and generate a bus transaction BT'. The second routing circuit RT2 may transmit the bus transaction BT' through the first bus channel B21 based on the identification information ID.

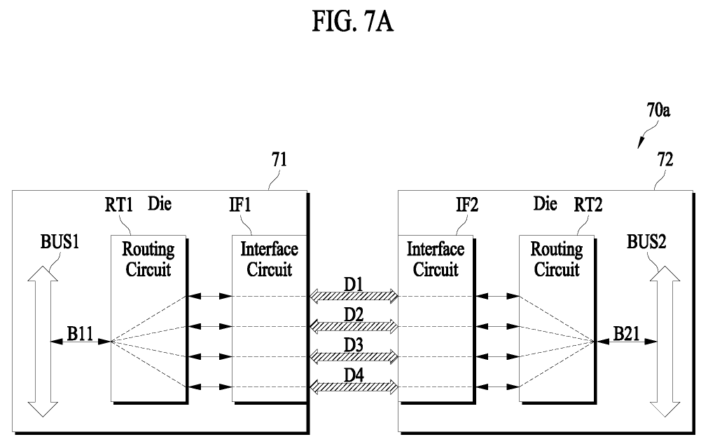

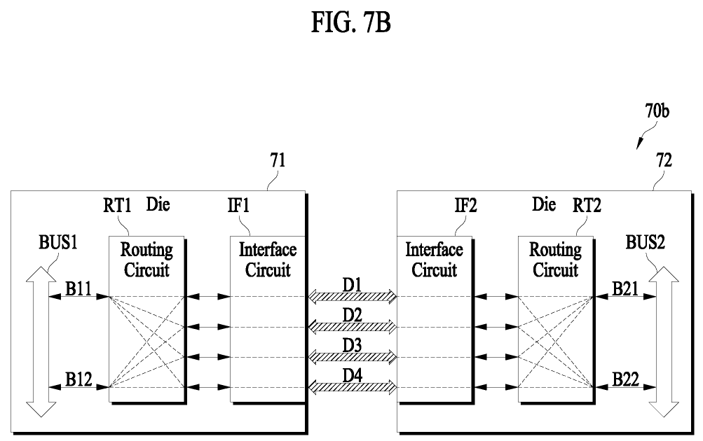

FIGS. 7A and 7B are block diagrams illustrating examples of a device. For example, a block diagram of FIG. 7A illustrates a device 70a where a system bus includes one bus channel, and a block diagram of FIG. 7B illustrates a device 70b where a system bus includes two bus channels. In some implementations, as illustrated in FIGS. 7A and 7B, the number of bus channels may be less than the number of D2D channels. As described later, bus transactions transmitted and received through a small number of bus channels may be transmitted and received through a larger number of D2D channels, which may accordingly increase the bandwidth. In the description of FIGS. 7A and 7B, it is assumed that the first die 71 transmits data to the second die 72 based on D2D communication, and redundant details already provided in the foregoing description will be omitted.

Referring to FIG. 7A, the device 70a may include a first die 71 and a second die 72 that mutually communicate through first to fourth D2D channels D1 to D4. The first die 71 may include a first bus BUS1, a first routing circuit RT1, and a first interface circuit IF1, and the second die 72 may include a second bus BUS2, a second routing circuit RT2, and a second interface circuit IF2. The first bus BUS1 may include a first bus channel B11, and the second bus BUS2 may also include a first bus channel B21.

The first routing circuit RT1 may receive a bus transaction through the first bus channel B11. The first routing circuit RT1 may generate D2D transactions from the bus transaction and identify the first to fourth D2D channels D1 to D4 based on channel mapping information. The first routing circuit RT1 may provide the D2D transactions to the first interface circuit IF1 to be interleaved and transmitted through the first to fourth D2D channels D1 to D4. In some implementations, as illustrated in FIG. 7A, when the number of bus channels included in the first bus BUS1 is one, the first routing circuit RT1 may omit tagging identification information of the first bus channel B11. The first interface circuit IF1 may transmit interleaved D2D transactions to the second die 72 through the first to fourth D2D channels D1 to D4.

The second interface circuit IF2 of the second die 72 may receive the D2D transactions through the first to fourth D2D channels D1 to D4. The second routing circuit RT2 may receive the D2D transactions from the second interface circuit IF2 and identify the first bus channel B21 based on identification information included in the D2D transactions. In some implementations, as illustrated in FIG. 7A, when the number of bus channels included in the second bus BUS2 is one, the second routing circuit RT2 may omit extracting and identifying identification information.

Referring to FIG. 7B, the device 70b may include a first die 71 and a second die 72 that mutually communicate through first to fourth D2D channels D1 to D4. The first die 71 may include a first bus BUS1, a first routing circuit RT1, and a first interface circuit IF1, and the second die 72 may include a second bus BUS2, a second routing circuit RT2, and a second interface circuit IF2. The first bus BUS1 may include a first bus channel B11 and a second bus channel B12, and the second bus BUS2 may also include a first bus channel B21 and a second bus channel B22.

The first routing circuit RT1 may receive bus transactions through the first bus channel B11 and the second bus channel B12. The first routing circuit RT1 may generate D2D transactions from the bus transactions received through the first bus channel B11 and the second bus channel B12. The first routing circuit RT1 may tag the D2D transactions, generated from a bus transaction received through the first bus channel B11, with first identification information of the first bus channel B11, and meanwhile, may tag the D2D transactions, generated from a bus transaction received through the second bus channel B12,with second identification information of the second bus channel B12. The first routing circuit RT1 may identify the first to fourth D2D channels D1 to D4 based on channel mapping information, and the first routing circuit RT1 may provide the D2D transactions to the first interface circuit IF1 to be interleaved and transmitted through the first to fourth D2D channels D1 to D4. The first interface circuit IF1 may transmit interleaved D2D transactions to the second die 72 through the first to fourth D2D channels D1 to D4.

The second interface circuit IF2 of the second die 72 may receive the interleaved D2D transactions through the first to fourth D2D channels D1 to D4. The second routing circuit RT2 may receive the D2D transactions from the second interface circuit IF2 and identify the first bus channel B21 or the second bus channel B22 based on identification information included in the D2D transactions. The second routing circuit RT2 may generate a first bus transaction by assembling the D2D transactions corresponding to the first bus channel B21 and transmit the first bus transaction through the first bus channel B21, and meanwhile, may generate a second bus transaction by assembling the D2D transactions corresponding to the second bus channel B22 and transmit the second bus transaction through the second bus channel B22.

FIG. 8 is a block diagram illustrating an example of a device 80. For example, FIG. 8 illustrates an example in which only some among a plurality of D2D channels are used for D2D communication. In the description of FIG, 8, it is assumed that a first die 81 transmits data to a second die 82 based on D2D communication, and redundant details already provided in the aforementioned description with reference to the diagrams will be omitted.

Referring to FIG. 8, the device 80 may include a first die 81 and a second die 82 that mutually communicate through first to fourth D2D channels D1 to D4. The first die 81 may include a first bus BUS1, a first routing circuit RT1, and a first interface circuit IF1, and the second die 82 may include a second bus BUS2, a second routing circuit RT2, and a second interface circuit IF2. The first bus BUS1 may include a first bus channel B11 and a second bus channel B12, and the second bus BUS2 may also include a first bus channel B21 and a second bus channel B22.

As illustrated in FIG. 8, each of the first bus channel B11 and the second bus channel B12 of the first bus BUS1 may be mapped to a third D2D channel D3 and a fourth D2D channel D4, and each of the first bus channel B21 and the second bus channel B22 of the second bus BUS2 may also be mapped to the third D2D channel D3 and the fourth D2D channel D4. Accordingly, as illustrated in FIG. 8, a first D2D channel D1 and a second D2D channel D2 may not be used in D2D communication.

The first routing circuit RT1 may provide a control signal to the first interface circuit IF1 to power down a sub-circuit of the first interface circuit IF1 based on channel mapping information. For example, as illustrated in FIG. 8, when it is identified that the first D2D channel D1 and the second D2D channel D2 are not used based on the channel mapping information, the first routing circuit RT1 may provide the control signal to the first interface circuit IF1 to allow sub-circuits corresponding to the first D2D channel D1 and the second D2D channel D2, for example, the first channel controller 41, the second channel controller 42, the first PHY circuit 45, and the second PHY circuit 46 of FIG. 4 to be powered down. The first interface circuit IF1 may power down the sub-circuits of the first interface circuit IF1 corresponding to the first D2D channel D1 and the second D2D channel D2 based on the control signal received from the first routing circuit RT1. The second routing circuit RT2 may also provide a control signal to the second interface circuit IF2, and the second interface circuit IF2 may power down sub-circuits of the second interface circuit IF2 corresponding to the first D2D channel D1 and the second D2D channel D2. Accordingly, power consumption of the device 80 may be reduced.

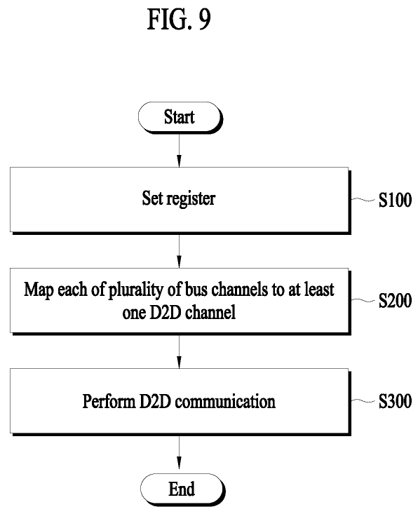

FIG. 9 is a flowchart illustrating an example of a method for D2D communication. As illustrated in FIG. 9, the method for D2D communication may include a plurality of operations S100 to S300. In some implementations, the method of FIG. 9 may be performed by the die 20 of FIG. 2, or by any of the die described herein. Hereinafter, FIG. 9 will be described with reference to FIG. 2.

Referring to FIG. 9, a register may be configured in operation S100. For example, the routing circuit 23 may include one or more registers. The at least one function block 21 may transmit a signal to the routing circuit 23 through the bus 22, and the routing circuit 23 may set the one or more registers based on the signal received through the bus 22. At least one configured register may store channel mapping information. In some implementations, the one or more registers may store information of a unit of interleaving, in other words, information about a size of a transaction. In some implementations, the routing circuit 23 may receive the signal through a dedicated channel from a function block controlling channel mapping, without passing through the bus 22, and may set the one or more registers based on a received signal.

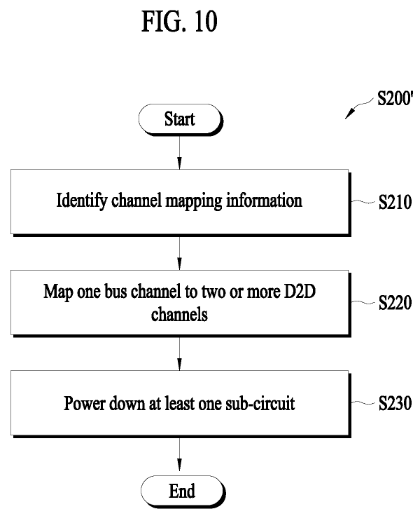

In operation S200, each of a plurality of bus channels may be mapped to at least one D2D channel. For example, the routing circuit 23 may map one bus channel to at least one D2D channel based on the channel mapping information stored in a register configured in the operation S100. An example of the operation S200 will be described later with reference to FIG. 10.

In operation S300, D2D communication may be performed. For example, the die 20 may perform D2D communication with another die through D2D channels. D2D transactions transmitted through D2D channels may be originated from a bus transaction transmitted through a bus channel mapped to a D2D channel in the operation S200. Accordingly, channels may be dynamically mapped, improving the performance and efficiency of D2D communication.

FIG. 10 is a flowchart illustrating an example of a method for D2D communication. For example, the flowchart of FIG. 10 illustrates the operation S200 of FIG. 9. As described above in FIG. 9, each of the plurality of bus channels may be mapped to at least one D2D channel in operation S200' of FIG. 10. As illustrated in FIG. 10, the operation S200' may include a plurality of operations S210 to S230. In some implementations, the operation S200' may be performed in the device 80 of FIG. 8, or in another of the devices described above. Hereinafter, FIG. 10 will be described with reference to FIG. 8.

Referring to FIG. 10, channel mapping information may be identified in the operation S210. For example, the first routing circuit RT1 may include one or more registers and identify channel mapping information based on a value stored in the one or more registers. As described above with reference to FIG. 9, the one or more registers may be configured by a function block external to the first routing circuit RT1.

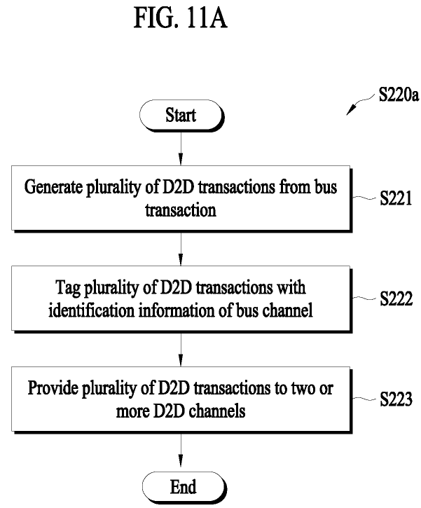

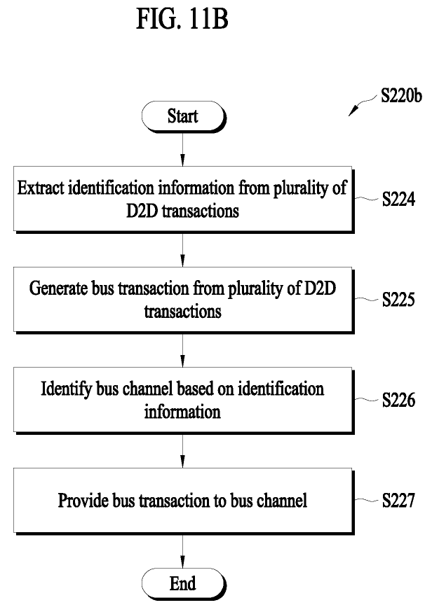

In operation S220, one bus channel may be mapped to two or more D2D channels. For example, the first routing circuit RT1 may identify that a bus channel included in the first bus BUS1, for example, the first bus channel B11 is mapped to the third D2D channel D3 and the fourth D2D channel D4, based on the channel mapping information identified in the operation S210. In addition, the first routing circuit RT1 may identify that the second bus channel B12 is mapped to the third D2D channel D3 and the fourth D2D channel D4 based on the channel mapping information. Examples of the operation S220 will be described later with reference to FIGS. 11A and 11B.

In operation S230, at least one sub-circuit may be powered down. For example, a D2D channel that is not used based on the channel mapping information identified in the operation S210 may be identified. The first interface circuit IF1 may power down the sub-circuits of the first interface circuit IF1 corresponding to the first D2D channel D1 and the second D2D channel D2 based on the control signal of the first routing circuit RT1. In addition, the second interface circuit IF2 may power down the sub-circuits corresponding to the first D2D channel D1 and the second D2D channel D2 based on the control of the second routing circuit RT2.

FIGS. 11A and 11B are flowcharts illustrating examples of a method for D2D communication. For example, the flowcharts of FIGS. 11A and 11B may illustrate the operation S220 of FIG. 10. As described above with reference to FIG. 10, in operation S220a of FIG. 11A and operation S220b of FIG. 11B, one bus channel may be mapped to two or more D2D channels. In some implementations, the operation 220a of FIG. 11A may be performed by the first routing circuit RT1 of FIG. 3, and the operation S220b of FIG. 11B may be performed by the second routing circuit RT2 of FIG. 3. Hereinafter, FIGS. 11A and 11B will be described with reference to FIG. 3.

Referring to FIG. 11A, the operation S220a may include a plurality of operations S221 to S223. In operation S221, a plurality of D2D transactions may be generated from a bus transaction. For example, the first routing circuit RT1 may generate the plurality of D2D transactions to transmit the bus transaction, received through each of the first to fourth bus channels B11 to B14, through the first to fourth D2D channels D1 to D4. In some implementations, the plurality of D2D transactions may have an identical size.

In operation S222, the plurality of D2D transactions may be tagged with identification information of a bus channel. For example, the first routing circuit RT1 may tag the plurality of D2D transactions with identification information corresponding to a bus channel that receives a bus transaction from which the plurality of D2D transactions are generated in the operation S221. Accordingly, the D2D transaction may include information about a bus channel corresponding to itself among the first to fourth bus channels B11 to B14.

In operation S223, the plurality of D2D transactions may be provided to two or more D2D channels. For example, the first routing circuit RT1 may provide the plurality of D2D transactions to the first interface circuit IF1 to allow the plurality of D2D transactions tagged with the identification information in the operation S222 to be interleaved and transmitted through the first to fourth D2D channels D1 to D4.

Referring to FIG. 11B, the identification information may be extracted from the plurality of D2D transactions in operation S224. For example, the second routing circuit RT2 may receive the plurality of D2D transactions from the second interface circuit IF2 and extract the identification information included in the plurality of D2D transactions. As described above, the identification information may be tagged by the first routing circuit RT1 and may represent a bus channel corresponding to a D2D transaction.

In operation S225, a bus transaction may be generated from the plurality of D2D transactions. For example, the second routing circuit RT2 may generate a bus transaction from the plurality of D2D transactions corresponding to an identical bus channel based on the identification information extracted in the operation S224.

In operation S226, a bus channel may be identified based on the identification information, and in operation S227, the bus transaction may be provided to the bus channel. For example, the second routing circuit RT2 may identify one of the first to fourth bus channels B21 to B24 based on identification information extracted in the operation S224. The second routing circuit RT2 may provide the bus transaction generated in the operation S225 to an identified bus channel in the operation S226.

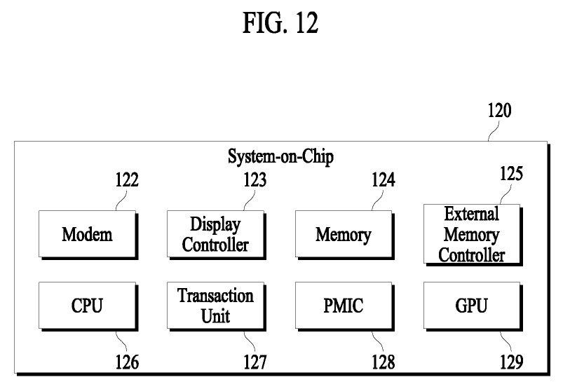

FIG. 12 is a block diagram illustrating an example of a system-on-chip (SoC). The SoC 120 may be a semiconductor device that implements complex blocks such as intellectual property (IP) cores that perform various functions on a single chip. The SoC 120 may include two or more dies that perform D2D communication described above with reference to the diagrams. Referring to FIG. 12, the SoC 120 may be function blocks and may include a modem 122, a display controller 123, a memory 124, an external memory controller 125, a central processing unit (CPU) 126, a transaction unit 127, a power management integrated circuit (PMIC) 128, and a graphic processing unit (GPU) 129.

A function block of the SoC 120 may be included in a single die together with another function block or implemented in a single die independently. When function blocks are distributed across two or more dies, the function block may have an optimal structure, and the yield of the SoC 120 may be improved. The function blocks included in a single die may communicate through a system bus, and meanwhile, function blocks included in different dies may perform D2D communication as described above.

The CPU 126 that may control the operation of the SoC 120 at the top level, may control the operations of other function blocks 122 to 129. The modem 122 may demodulate a signal received from outside the SoC 120 or modulate a signal generated inside the SoC 120 to transmit to the outside. The external memory controller 125 may control an operation of transmitting and receiving data from an external memory device connected to the SoC 120. For example, a program and/or data stored in the external memory device may be provided to the CPU 126 or GPU 129 under the control of the external memory controller 125. The GPU 129 may execute program instructions related to graphic processing. The GPU 129 may receive graphic data through the external memory controller 125, and transmit the graphic data handled by the GPU 129 to the outside the SoC 120 through the external memory controller 125. The transaction unit 127 may monitor a data transaction of each function block, and the PMIC 128 may control power supplied to each of the function block based on a control of the transaction unit 127. The display controller 123 may transmit data generated within the SoC 120 to a display by controlling the display (or a display device) outside the SoC 120. The memory 124 may include a non-volatile memory such as an electrically erasable programmable read-only memory (EEPROM) or a flash memory, or a volatile memory such as a dynamic random access memory (DRAM) or a static random access memory (SRAM).

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While various examples are described in detail above, the scope of the present disclosure is not limited thereto, and it will be apparent to those of ordinary skill in the art that modifications and variations may be made without departing from the scope of the present disclosure. In addition, the aforementioned implementations may be implemented with some elements removed, and each example may be implemented in combination with each other.

What is claimed is:

1. A die, comprising:
a bus including a plurality of bus channels;
at least one function block connected to the bus;
an interface circuit configured to provide communication with another die through a plurality of die-to-die (D2D) channels; and
a routing circuit configured to perform channel mapping between the plurality of bus channels and the plurality of D2D channels based on a signal received from the bus.

2. The die of claim 1, wherein the routing circuit is configured to map a first bus channel of the plurality of bus channels to two or more D2D channels of the plurality of D2D channels.

3. The die of claim 2, wherein the routing circuit is configured to:
generate a plurality of first D2D transactions from a bus transaction received from the first bus channel; and
provide the plurality of first D2D transactions to the two or more D2D channels.

4. The die of claim 3, wherein the routing circuit is configured to generate the plurality of first D2D transactions based on an address used for the bus transaction.

5. The die of claim 3, wherein the routing circuit is configured to tag the plurality of first D2D transactions with first identification information identifying the first bus channel.

6. The die of claim 3, wherein the routing circuit comprises a register configured based on the signal, and
wherein the routing circuit is configured to determine a size of each first D2D transaction of the plurality of first D2D transactions based on a value stored in the register.

7. The die of claim 3, wherein the routing circuit is configured to:
map a second bus channel of the plurality of bus channels to the two or more D2D channels;
generate a plurality of second D2D transactions from a second bus transaction received through the second bus channel; and
provide the plurality of second D2D transactions to the two or more D2D channels.

8. The die of claim 2, wherein the routing circuit is configured to:
generate a first bus transaction from a plurality of first D2D transactions received from the two or more D2D channels; and
provide the first bus transaction to the first bus channel.

9. The die of claim 8, wherein the routing circuit is configured to:
extract first identification information from the plurality of first D2D transactions; and
identify the first bus channel based on the first identification information.

10. The die of claim 2, wherein the interface circuit is configured to, based on the mapping of the first bus channel to the two or more D2D channels, power down at least one sub-circuit of the interface circuit,
wherein the at least one sub-circuit corresponds to at least one D2D channel excluded from the two or more D2D channels and included in the plurality of D2D channels.

11. The die of claim 1, wherein the routing circuit comprises a register configured based on the signal and is configured to perform the channel mapping based on a value stored in the register.

12. A method of communicating between a die and another die through a plurality of die-to-die (D2D) channels, the method comprising:
mapping each bus channel of a plurality of bus channels included in a bus to at least one D2D channel of the plurality of D2D channels, wherein the bus is connected to at least one function block of the die,
wherein the mapping includes mapping a first bus channel of the plurality of bus channels to two or more D2D channels of the plurality of D2D channels.

13. The method of claim 12, wherein the mapping of the first bus channel to the two or more D2D channels comprises:
generating a plurality of first D2D transactions from a bus transaction transmitted through the first bus channel; and
providing the plurality of first D2D transactions to the two or more D2D channels.

14. The method of claim 13, wherein the mapping of the first bus channel to the two or more D2D channels comprises tagging the plurality of first D2D transactions with first identification information identifying the first bus channel.

15. The method of claim 13, wherein the mapping of each bus channel to at least one of the plurality of D2D channels comprises mapping a second bus channel of the plurality of bus channels to the two or more D2D channels, and
wherein the mapping of the second bus channel to the two or more D2D channels comprises:
generating a plurality of second D2D transactions from a bus transaction transmitted through the second bus channel; and
providing the plurality of second D2D transactions to the two or more D2D channels.

16. The method of claim 12, wherein the mapping of the first bus channel to the two or more D2D channels comprises:
generating a first bus transaction from a plurality of first D2D transactions received from the two or more D2D channels; and
providing the first bus transaction to the first bus channel.

17. The method of claim 16, wherein the mapping of the first bus channel to the two or more D2D channels comprises:
extracting first identification information from the plurality of first D2D transactions; and
identifying the first bus channel based on the first identification information.

18. The method of claim 12, comprising, based on the mapping of the first bus channel to the two or more D2D channels, powering down at least one sub-circuit of an interface circuit, wherein the at least one sub-circuit corresponds to at least one D2D channel excluded from the two or more D2D channels and included in the plurality of D2D channels.

19. The method of claim 12, further comprising configuring a register based on a signal transmitted through the bus, and
wherein the mapping of each bus channel to at least one of the plurality of D2D channels comprises identifying mapping information based on a value stored in the register.

20. A device comprising a first die and a second die communicatively connected through a plurality of die-to-die (D2D) channels,
wherein the first die comprises:
a first bus including a plurality of first bus channels, and
a first routing circuit configured to perform first channel mapping between the plurality of first bus channels and the plurality of D2D channels,
wherein the second die comprises:
a second bus including a plurality of second bus channels; and
a second routing circuit configured to perform second channel mapping between the plurality of second bus channels and the plurality of D2D channels, and
wherein a mapping between each first bus channel of the plurality of first bus channels and one or more D2D channels of the plurality of D2D channels, is identical to a mapping between a corresponding second bus channel of the plurality of second bus channels and the one or more D2D channels of the plurality of D2D channels.
